(19) United States
(12) Patent Application Publication
(10) Pub. No.: US 2014/0230055 A1
(43) Pub. Date: Aug. 14, 2014

(54) METHOD FOR CHECKING AN M OUT OF N CODE

(71) Applicant: ROBERT BOSCH GMBH, Stuttgart (DE)

(72) Inventor: Eberhard Boehl, Reutlingen (DE)

(21) Appl. No.: 14/130,835

(22) PCT Filed: Jun. 19, 2012
(86) PCT No.: PCT/EP2012/061706

§ 371 Date: Apr. 18, 2014

(30) Foreign Application Priority Data
Jul. 5, 2011 (DE) 102011078642.2

(51) Int. Cl. G06F 21/57

(52) U.S. Cl. CPC G06F 21/57
USPC 726/22

(57) ABSTRACT

A method and a circuit system for checking an m out of n code are provided. The method uses a code checker, to which at least one code reducer is assigned, a reduction of the code word width to in each case half being carried out using the at least one code reducer until a 1 out of x (x=n/2, n/4, n/8 . . . ) code or another code which is not reducible further in this way is provided, each step of the code reducer additionally being connected to different bits of a counter, the 1 out of x code or the code which is not further reducible being checked and additionally the signal pairs of each step being checked.

### FIELD OF THE INVENTION

The present invention relates to a method for checking an m out of n code and a circuit system for carrying out the provided method, which is also designated as a tester or checker.

### BACKGROUND INFORMATION

Redundant codes are used in security-relevant systems, in which in case of an error, the error is recognized by a code checker and thus a critical situation may be avoided. M out of n codes also play a role. In addition, random number generators are required for cryptographic applications, which are to have a self-test according to the recommendation of the NIST (National Institute of Standards and Technology) (see in this regard special publication “Recommendation for Random Number Generation Using Deterministic Random Bit Generators”, STD 800-90, March 2007). The implementation of a self-test may cause a high outlay for arbitrary deterministic random number generators. If an m out of n code is used for the implementation, the recommended self-test may be implemented simply by a code checker.

An m out of n code is an error detection code having a code word length of n bits, each code word including precisely m instances of a one.

To generate an m out of n code, for example, a mask generator having m out of n coding may be used. A possible construction of such a mask generator is shown, for example, in FIG. 1 and will be explained at the appropriate point herein.

Mask generators are subjected to attacks, like other cryptographic devices and cryptological algorithms, using which protected data are to be manipulated or read out. In the present conventional encryption methods, for example, the advanced encryption standard (AES), keys are used, which are not ascertainable by “trial and error” (so-called brute force attacks) as a result of the key length of 128 or more bits, even when employing rapid computer technology. An attacker therefore also studies secondary effects of an implementation, such as the time curve of the power consumption, the duration with respect to time, or the electromagnetic emission of a circuit during the encryption operation. Since the attacks are not targeted directly on the function, such attacks are also designated as side channel attacks.

These side channel attacks (SCA) use the physical implementation of a cryptosystem in a device. The control unit having cryptographic functions is observed during the execution of the cryptological algorithms, to find correlations between the observed data and the hypotheses for the secret key.

Numerous side channel attacks are known, as are described, for example, in the publication of Mangard, Oswald, and Popp in “Power Analysis Attacks,” Springer 2007. In particular, a successful attack on the secret key of the AES may be carried out practically using the differential power analysis (DPA).

In the case of a DPA, the power consumption of a microprocessor during cryptographic calculations is recorded and traces of the power consumption are compared to hypotheses by statistical methods.

In the case of known methods, which make DPA more difficult, an intervention is made in the algorithm itself. In the case of masking, the operations are executed using randomly changed operands and as a result the random value is then eliminated again, which means that the random number does not have an effect on the result. A further possibility is so-called hiding, in which one attempts to compensate for high-low transitions by corresponding low-high transitions.

Modem cryptographic methods, for example, the advanced encryption standard (AES) are, as already described above, well protected against so-called brute force attacks, i.e., trial and error of all possibilities, by the length of the keys and the complexity of the method, even with the current state of computing technology. The attacks of a potential attacker are therefore increasingly oriented to the implementations. The attacker attempts using so-called side channel attacks to obtain items of information about the power consumption during the processing of the algorithm via the electromagnetic emission or the operand-dependent duration with respect to time of the processing, which permit the secret key to be inferred.

One possibility for improving the robustness against such side channel attacks, in a mask generator, is to use a system of identically built up state machines, to which an input signal is supplied on the input side and which generate an output signal as a function of their state, each state machine always having a different state than the other state machines of the system. It is presumed that due to the equal number in each case of ones and zeros (and therefore an equal Hamming weight) and due to transitions of the states in the case of identical input signals having an identical Hamming distance in each case, the power consumption is independent of the particular state of the state machines used.

It is known that by way of so-called error attacks, a circuit may be brought into a state which is actually not provided for normal operation. This non-normal operation offers the possibility of ascertaining the secret key more easily. Thus, for example, by targeted change of the operating voltage (spike attack), by electromagnetic fields, or by emission of, for example, alpha particles or lasers, a change of the state of individual or all used state machines into a state (0, 0, . . . , 0) may be caused. If a bit vector thus generated is used to mask a key, the originally provided protection of the key from side channel attacks is entirely or at least partially lost. The secret key is therefore ascertainable more easily. By way of special code checkers, in particular in the case of m out of n codes, it may be checked very easily whether one or also multiple bits (in particular in one direction) have been corrupted.

Such code checkers are described, for example, in the publication by A. P. Stroele and S. Tarnick, Programmable Embedded Self-Testing Checkers for All-Unidirectional Error Detecting Codes, Proceedings of the 17th IFEE VLSI Test Symposium, Dana Point, Calif., 1999, pages 361 through 369. A code checker is described therein, the code checker monitoring the outputs of a system to detect occurring errors as rapidly as possible. The checker is constructed from a number of full adders and flip-flops and has a uniform structure. In a further publication by S. Tarnick, Design of Embedded Constant Weight Code-Checkers Based on Averaging Operations, Proceedings of the 16th IEEE On-Line Testing Symposium, Corfu Island, Greece, 2010, pages 255-260, a simplified circuit for the same purpose is described.

PCT Publication No. WO 2006/003023 A2 describes a method and a system for recognizing unidirectional errors in words of systematic disordered codes. This system also includes a number of full adders and flip-flops. The system, which includes a translation circuit and a Berger type code checker, may be tested using a small number of code words.

The code checkers described in the cited publications are constructed in such a way that they self-test. For this purpose, the code space is reduced using a first checker in such a way that only half of the code bits are still present and also only half thereof have the value 1 (m/2 out of n/2). This procedure is carried out, for example, until a 1 out of 2 code is provided (dual-rail code). However, this is only possible if m=n/2.

This dual-rail code is finally checked in a self-testing dual-rail code checker, as is described, for example, in the following article: S. Kundu, S. M. Reddy, Embedded Totally Self-Checking Checkers A Practical Design, Design and Test of Computers, 1990, volume 7, edition 4, pages 5 through 12.

### SUMMARY

Against this background, a method for checking an m out of n code and a circuit system for carrying out the method are presented.

A self-test of an above-mentioned mask generator or a signature may be carried out using the provided method. A self-test in cryptographic structures is advantageous, since otherwise a test having various input and output signals possibly discloses more to an attacker than the cryptographic operation itself. The described method and the described circuit system additionally allow an error attack to be recognized and the output of a mask or a signature to be prevented in this case. An error attack may corrupt individual bits or also a plurality of bits. All unidirectional multiple errors are to reliably recognized, because otherwise the mask becomes completely ineffective. In addition, it is also possible to recognize multiple errors which are not unidirectional. Even if no errors may be recognized by the code checker at the point in time of the error injection due to the compensation of single bit errors, it is possible that in the course of the further processing of input signals, a state will occur which results in the error recognition in the code checker.

If the provided circuit system, which is also designated hereafter as a code checker, is used in conjunction with the mask generator described at the outset, it may be checked, during the operation or also at the end of the mask generation before the output of the valid mask, whether an error has occurred. If the code does not correspond, the output of the mask is prevented and therefore the provided cryptographic operation is not carried out. An attacker therefore has no chance of an operation having corrupted masking data. In contrast to the above-mentioned code checkers according to the related art, however, the outlay may be significantly reduced, without the property of self-testing being lost.

Further advantages and embodiments of the present invention result from the description and the appended drawings.

It is clear that the above-mentioned features and the features to be explained hereafter are usable not only in the particular specified combination, but rather also in other combinations or alone, without departing from the scope of the present invention.

### BRIEF DESCRIPTION OF THE DRAWINGS

FIG. 1 shows one specific embodiment of a mask generator.

FIG. 2 shows a code reducer (weight averaging circuit) as a first step of an 8 out of 16 code reducer.

FIG. 3 shows a three-step code reducer for m out of n code with m=8 and n=16.

FIG. 4 shows a two-rail code checker TRC.

FIG. 5 shows the formation of an error signal error from the dual-rail signals from FIG. 3.

### DETAILED DESCRIPTION

The present invention is schematically shown on the basis of specific embodiments in the drawings and will be described in greater detail hereafter with reference to the drawings.

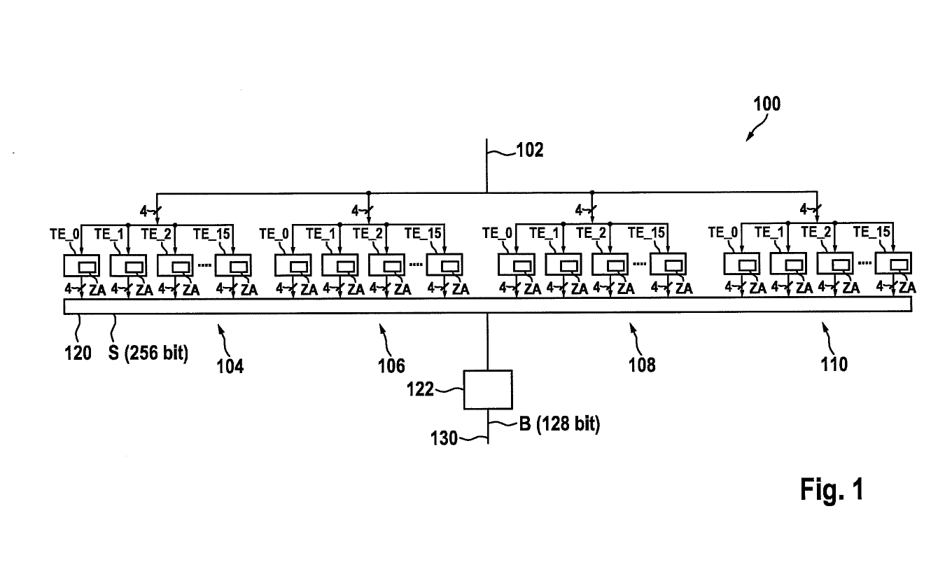

FIG. 1 schematically shows a specific embodiment of a mask generator, which is designated as a whole with reference numeral 100. This mask generator 100 is used to produce a bit vector having 128 bits from an input signal 102. For this purpose, circuit system 100 includes four systems 104, 106, 108, and 110, which each include 16 transformation elements TE_0, TE_1, TE_2, . . . , TE_15. For the sake of clarity, only four of the sixteen transformation. elements TE_0, TE_1, TE_2, . . . , TE_15 are shown in each case in FIG. 1. In this embodiment, mask generator 100 is designed in such a way that each transformation element TE_0, TE_1, TE_2, . . . , TE_15 of each of systems 104, 106, 108, and 110 is supplied with the same input data or the same input signal 102. In each system 104, 106, 108, 110, all transformation elements TE_0, TE_1, TE_2, . . . , TE_15 are similarly connected to the input signals, but different systems 104, 106, 108, and 110 may also differ from one another.

Transformation elements TE_0, TE_1, TE_2, . . . , TE_15 produce an output signal (not described in greater detail here) from input signal 102 supplied thereto. These output signals are combined and a signature S 120 having 256 bits is obtained therefrom. Transformation elements TE_0, TE_1, TE_2, . . . , TE_15 each have a state machine ZA, whose items of state information are stored, for example, in the form of a digital data word of pre-definable width.

For example, state machine ZA may have a storage capacity of four bits, so that a total of 16 different states are possible. State machines ZA of each system 104, 106, 108, 110 are designed similarly. Similarly means that each state machine ZA, proceeding from identical input signals 102 and an identical initialization state, will assume the same resulting state in a following processing cycle as another similar state machine ZA.

Furthermore, it is provided that each state machine ZA always has a different state in each case than all other state machines ZA of corresponding systems 104, 106, 108, or 110. DPA attacks which attempt, from the analysis of an electrical current and/or power consumption or from interfering emissions, to draw conclusions about an internal processing state of circuit system 100 or individual transformation elements TE_0, TE_1, TE_2, . . . , TE_15 are thus made more difficult.

It is advantageous if the number of provided transformation elements TE_0, TE_1, TE_2, . . . , TE_15 corresponds to the number of the maximum possible different states of state machine ZA, in this case 16. Every theoretically possible state is thus always, i.e., in every processing cycle, provided in precisely one state machine ZA, so that in each case only a combination of all 16 possible states is “visible” from the outside, i.e., with respect to a possible attacker who carries out a DPA attack. In a following processing cycle, in which individual state machines ZA typically each change their state in accordance with a predefined rule, again precisely one of the sixteen possible states is provided overall in each of sixteen state machines ZA, so that again all sixteen states are simultaneously “visible” from the outside.

As a result, a possible attacker may not conclude from a corresponding electromagnetic emission, which is provided in the event of a conventional implementation of circuit system 100, or from the electrical power consumption of circuit system 100, a state of the internal signal processing in transformation elements TE_0, TE_1, TE_2, . . . , TE_15. In the case of an ideal symmetrical design of all components, the electrical power consumption is always constant, so that the emitted electromagnetic field in each case does not experience any significant changes during a state change between successive processing cycles. A bit vector 130 having 128 bits is generated from signature S 120 by a linear linkage in block 122. The linear linkage may be, for example, an EXOR or also an EXNOR linkage. To make the work of the potential attacker even more difficult, the outputs of the various transformation elements are exchanged before the linear linkage. A reasonable measure for this purpose is the rotation of the states within a system as a function of the input data.

Illustrated mask generator 100 uses so-called nonlinear signature production. It is therefore known how a structure may be built up, from p identically built up state machines each having q state bits, which has a power consumption independent of the particular state of these state machines. For this purpose, a complete set of the state machines (COmplete Set of State MAchines COSSMA) is provided. This is provided precisely when p=2q. If each state machine has a different starting state, automatically (p*q)/2 ones and precisely as many zeros are provided in the p*q bits. Furthermore, all of these state machines of such a system are provided with the same input signals. If each of these state machines, in the case of an arbitrary input signal, always has an unambiguous succeeding state and an unambiguous precursor state, the states of the m state machines are different from one another at every time and therefore automatically it corresponds to a complete set of all possible states. Therefore, at every point in time of the processing of input data, a (p*q)/2 out of (p*q) code is provided.

In a practical example, q=4 and therefore p=2⁴=16. If the 16 state machines then always have the states 0, 1, 2, . . . , 15 provided, only the position of these states changes arbitrarily. With p*q=64, precisely 32 ones and 32 zeros are always provided at the outputs of all of these state machines. This 32 out of 64 code could be checked using a code checker as described above according to the related art. However, such a code checker would be very complex, because even in a first reduction step in a circuit for a weighted averaging for the code reduction, a so-called weight averaging circuit WAC, 32 full adder cells and additionally two flip-flops would be necessary. In the second step, 16 full adders and two flip-flops would be necessary and so forth, until only two full adders and two flip-flops would still be necessary. With 62 full adders (approximately 8 GE), 10 flip-flops (approximately 8 GE), and 6 dual-rail checkers (approximately 4 GE), the overall outlay would be set at approximately 600 gate equivalents (GE). If one carried this out for a fourfold structure having 4*64 bits, one would thus have a total of approximately 2400 gates in circuitry outlay in the parallel implementation.

In contrast, the implementation according to the present invention utilizes the fact that in the same bit positions of the state machines at every point in time, an equal number of ones are present. The testing may thus be split and in each case only 16 bits may be tested in one check step. The further 3×16 bits are tested in three further check steps. In contrast to the code checkers provided according to the related art, the flip-flops before and after the full adders in the weight averaging circuit may be omitted completely, if a counter provided in the circuit in any case is utilized and in each case one bit thereof is used on a weight averaging circuit WAC (code reducer), for example, as an input x₀. To implement the circuit as self-testing, the carry-in inputs of the weight averaging circuit and the dual-rail checker assume all possible combinations at least once.

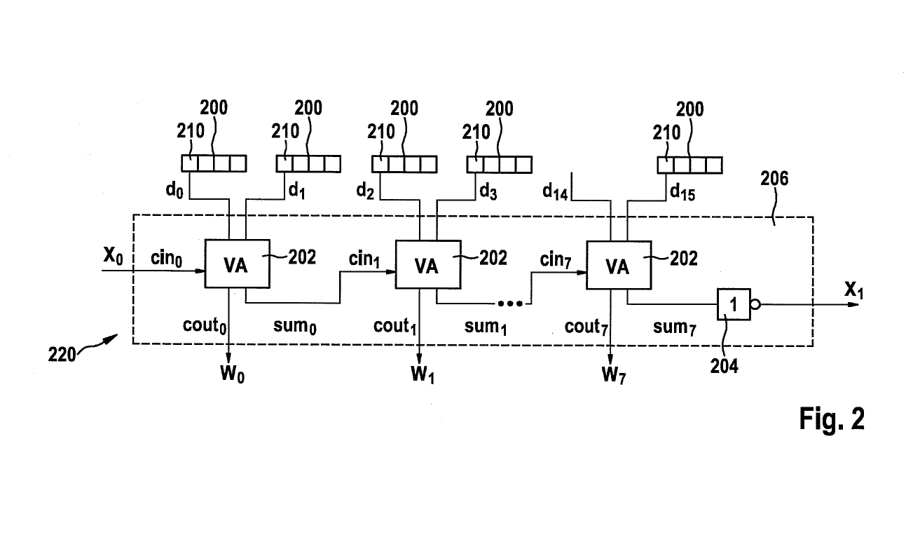

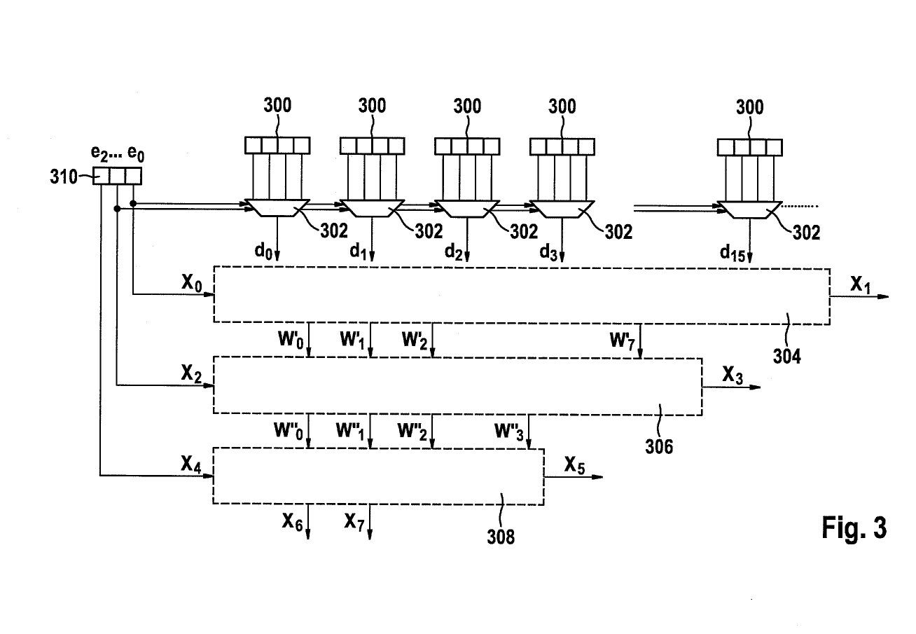

FIG. 2 shows such a weight averaging circuit (code reducer) WAC_{—}16 (without the flip-flops typical according to the related art) for 16 input bits d₀ . . . d₁₅. The illustration shows 16 state machines 200 each having 4 bits, of which 5 are shown in this illustration. Furthermore, according to FIG. 2, eight full adders 202 are provided, of which only three are shown for the sake of clarity, and a NO gate 204. A code reducer (WAC) 206 is shown framed by a dashed line. It represents one step 220 of a three-step code reducer shown in FIG. 3, which is identified in the step 220 with reference numeral 304.

In this circuit, the MSBs of the 16 state machines are used as input bits. If the 16 state machines all have a different state, then precisely 8 ones (8 out of 16 code) are contained in the 16 input bits. As shown in the literature according to the related art (Stroele, Tarnick), a 4 out of 8 code is generated at the 8 outputs w′₀, w′₁, . . . w′₇ of 304 precisely if the input was an 8 out of 16 code and the reducing circuit did not contain any errors. Input x₀ generates an output x₁ with x₁=/x₀, if no errors are present. A 1 out of 2 code is therefore provided for this first signal pair. To ensure the property of self-testing, xₒ must frequently change, and d₀ . . . d₁₅ are also not to be constant.

Summation bits are designated with sumₙ (n=0, 1, 2 . . . ), transfer input bits of the full adder are designated with cinₙ (n=0, 1, 2 . . . ). The transfer output bits (the outputs of full adders 202) are coutₙ (n=0, 1, 2 . . . ), which are transferred as signals wₙ (n=0, 1, 2 . . . ) into the next step.

Finally, a three-step code reducer is shown in FIG. 3. The illustration again shows state machines 300 each having 4 bits, a corresponding number of 4 to 1 multiplexers 302, a first WAC 304 (WAC_{—}16), a second WAC 306 (WAC_{—}8), and a third WAC 308 (WAC_{—}4), and a counter 310. In addition to above-described signal pair x₀, x₁, signal pairs x₂, x₃ and x₄, x₅ are also provided at the other step, which correspond in the error-free case to a 1 out of 2 code. These signal pairs are checked together with the reduced code. A multistep code reducer is referred to in the present case. The system shown in FIG. 3 may also be designated as a system which includes three code reducers, WAC 304 (WAC_{—}16), WAC 306 (WAC_{—}8), and WAC 308 (WAC_{—}4).

All 4 to 1 multiplexers 302 are activated similarly via counter bits e₀ and e₁ in such a way that they each select the same position bit of state machines 300 as bit gᵢ. A specific bit from each one of the 16 connected state machines 300 is therefore selected depending on the 4 states of these 2 counter bits, which is then processed in WAC_{—}16 304. In the error-free case, these inputs are to correspond to an 8 out of 16 code. The 8 outputs w′₀, w′₇ of WAC_{—}16 result in a 4 out of 8 code and are connected to the inputs of WAC_{—}8 306. WAC_{—}8 306 is constructed similarly to WAC_{—}16 304, but only has half as many full adders and the last summation bit is switched inverted to output x₃. Further provided WAC_{—}4 308 only has two full adders and two outputs, to which the carry-out of these full adders is switched: x₆ and x₇. Additional output x₅ is the inverted summation output of the second full adder in WAC_{—}4 308.

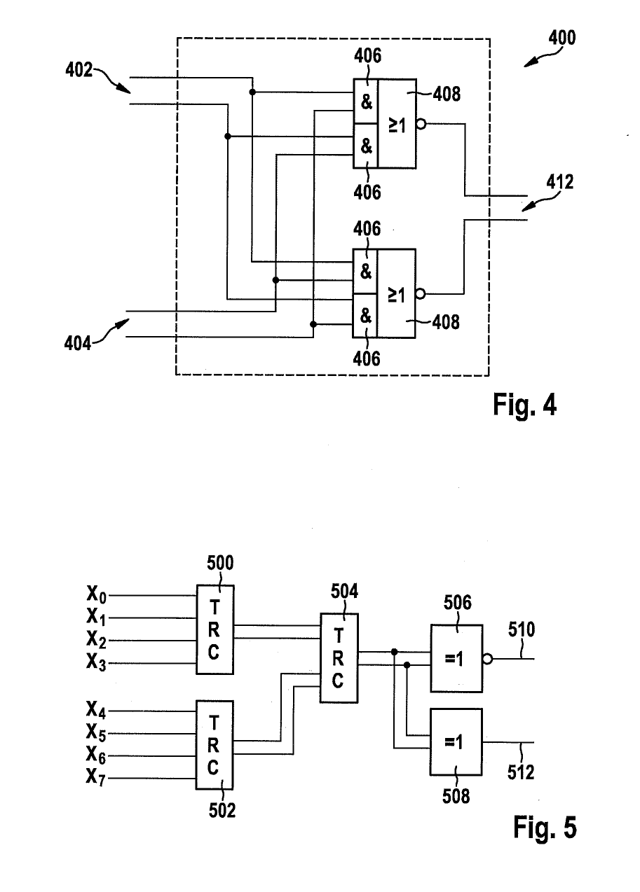

In the error-free case, particular pairs x₀ and x₁, x₂ and x₃, x₄ and x₅, and x₆ and x₇ each deliver a “dual-rail code” (or 1 out of 2 code), i.e., precisely one signal of these pairs is always 1. It is sufficient to test whether this property is met for all of these signal pairs. This test is carried out in so-called code checkers, for example, a two-rail code checker TRC according to FIG. 4.

In this case, e₂ . . . e₀ is an event counter, which is incremented with each code check (in each case 16 bits of the 64 are checked in 4 phases).

FIG. 4 shows a code checker 400, in this case a two-rail checker TRC. This TRC 400 has a first input 402 and a second input 404. Furthermore, the illustration shows two complex gates, which each link two times two different inputs by an AND element 406; the two outputs of this AND element 406 are subsequently linked and inverted by an OR element 408. The AND-OR and inverting elements may be implemented in a complex gate in such a way that they may not be isolated, or also in separate elements.

TRC 400 forms, from two dual-rail coded signals at the two inputs 402 and 404, one dual-rail output signal at an output 412. If the dual-rail code in both input signal pairs of inputs 402 and 404 is not violated and TRC 400 itself operates error-free, output 412 is also formed as a dual-rail pair.

As shown in FIG. 5, the x signals of FIG. 3 may be combined in such TRCs to form a single dual-rail pair. The figure shows a first TRC 500, a second TRC 502, a third TRC 504, an equivalence element 506, and an anti-valence element 508.

A code error is present if these two output signals of dual-rail checker 504 are equal. Signal “error” 510 is equal to 1 and “non-error” 512 is equal to 0, as soon as the two outputs of 504 are equal. In the error-free case, 510 is equal to 0 and 512 is equal to 1. If input signals x₀, x₂, and x₄ assume any arbitrary combination, the TRCs are self-testing. This property is ensured by counter bits e₂ . . . e₀, if the counter counts through from 0 through 7. The code of the counter is arbitrary (binary code, gray code, excess-3 code, counting forward or backward), as long as all allocations of the bits used occur in the sequence. The signal “error” at output 510 of equivalence element 506 in FIG. 5 either means a code error or an error in the code checker itself. To recognize an error in equivalence element 506 itself (which outputs the error signal at an output 510), the signal/error is output redundantly via anti-valence element 508 (EXOR) at an output 512.

The code checker according to FIG. 5 in conjunction with the code reducers or the multistep code reducer from FIG. 3 may now be used in the mask generator according to FIG. 1 as follows:

1. Checking is performed immediately in the input phase of each 16 code bits of a COSSMA system (COSSMA, COmplete Set of State MAchines), in the present example 16 state machines each having 4 bits. Through this parallel check during the generation of the masks, in each case 16 out of the 64 bits of a COSSMA system may be checked in each input vector (including the parities). After four cycles, in each case the entire COSSMA system is checked. If errors occur, the further mask generation is terminated. This prevents an attacker from being able to observe the power profile of the interfered circuit, which is changed by an infiltrated error. However, the self-test circuit itself must be prevented from offering an attacker more possibilities for an attack. This is made more difficult in particular because the attacker must place hypotheses on all bits of the initial state of a COSSMA. Since the input bits act similarly on all state machines of a COSSMA system, an attack on individual state bits is not promising.
2. The check after completed rotation. This variant has the advantage that the individual state machines depend on average on all bits of the initial state of a COSSMA. Furthermore, this method has the advantage that an error, which is only infiltrated after the rotation, is recognized and the generation of a mask is also still prevented then. A disadvantage is that errors infiltrated in the input phase are not recognized, and then the changed power behavior may possibly be utilized by an attacker.
3. A combination of 1 and 2: The COSSMA is continuously monitored for 16 bits in each case.

The provided circuit requires 14 full adders (each 8 GE), 3 inverters (each 0.5 GE), 16×4:1 multiplexers (each 7.5 GE), 3 TRCS (each 4 GE), and 2 XOR/XNOR (each 2.5 GE). In total this makes up approximately 250 GE and therefore substantially less than the above-mentioned proposal having 600 GE. For 4 COSSMA structures, therefore either 250=1000 GE are required, or the operation is carried out successively for the 4 structures on the same hardware and additionally 64×4:1 multiplexers having 480 GE are required, i.e., a total of approximately 750 GE.

In a generalization of the method according to the present invention, other codes, which do not meet the condition m=n/2, may also be checked.

For the case in which m n/2, the m out of n code may not be returned via multiple steps to two bits as in FIG. 2 (x₆ and x₇). For example, if m=4 and n=16, thus only two steps of the type shown are possible. Outputs w″₀ . . . w″₃ then form a 1 out of 4 code, which may be checked using conventional code checkers and delivers a dual-rail output.

If m=2 and n=16, only the first step according to FIG. 2 may be carried out. The code at outputs w′₀, . . . w′₇ is a 1 out of 8, which may also be checked using conventional code checkers and delivers a dual-rail output. These dual-rail outputs of the conventional code checker are checked in the TRCs according to FIG. 4 having the other dual-rail signal pairs.

Therefore, in the embodiment, a circuit system for checking an m out of n code having at least one code checker is described, which is suitable in particular for carrying out the provided method, the at least one code checker being assigned at least one code reducer or a one step or multistep code reducer, at least one step of this code reducer including multiple full adders; in the first step n/2 full adders are used, in which the summation bit of one full adder is led in each case to the transfer input of the next full adder and the n/2 transfer bits of the n/2 full adders are output. Furthermore, it may be provided that the transfer input of the first full adder is connected to the output of a first counter bit and the summation output of the last full adder is output, and the first counter bit and the summation bit of the last full adder form a first signal pair.

Furthermore, it may be provided that the second step of the code checker includes n/4 full adders, and the n/2 output bits of the first step are connected to the operand inputs of the n/4 full adders of the second step of the code checker, the summation bits of the full adders each being switched to the transfer input of the next full adder and the n/4 transfer bits of the n/4 full adders being output, a second counter bit being switched to the transfer input of the first full adder of the second step and this second counter bit, together with the output summation bit of the last full adder of the second step, fowling a second signal pair.

In addition, further steps of the code reducer may be added on, as long as only up to 2 transfer bits from 2 full adders may still be output, which form a dual-rail signal pair (for m=n/2), or another suitable code checker is connected to one of the steps (for m≠n/2) and in either the last step, for the case m=n/2, a last signal pair is formed from the connected last counter bit and the summation output of the second full adder or a code checker checks the code of the preceding step and outputs a dual-rail signal pair.

For the signal pairs (first, second, last), in each case a signal may be inverted and therefore modified signal pairs may be formed. These modified signal pairs together with the dual-rail signal pair are led to a two-rail checker connected to one another in such a way that a last two-rail checker outputs a signal pair which, in case of error freedom of the code and the code checker, forms a 1 out of 2 code and a check may be carried out for errors in the m out of n code or in the check circuit itself

The mentioned counter bits may vary in such a way that all states of these counter bits are assumed during successive check steps (of one or more code words), and various code words may be selected for checking using various counter bits.

Furthermore, the m out of n code to be checked may be split into multiple partial codes. These partial codes may be checked successively on the same code checker. For this purpose, the inputs of the code checker may be switched over between the various partial codes.

Alternatively, these partial codes may be checked simultaneously on various code checkers.

1-10. (canceled)

11. A method for checking an m out of n code, comprising:
providing at least one code checker;
assigning to the code checker at least one code reducer;
in the at least one code reducer, carrying out a reduction of a code word width to in each case half until one of a 1 out of x (x=n/2, n/4, n/8 . . . ) code and another code which is not reducible further in this way is provided;
connecting each of the at least one code reducer to different bits of a counter;
checking the at least one of the 1 out of x code and the code which is not reducible further; and
checking signal pairs of each of the at least one code reducer.

12. The method as recited in claim 11, wherein the at least one code reducer includes multiple code reducers that are assigned.

13. The method as recited in claim 11, wherein the code check is carried out multiple times for various partial codes.

14. The method as recited in claim 13, wherein different counter states are provided for each partial code check.

15. The method as recited in claim 13, wherein the partial codes are successively checked using the same code checker.

16. The method as recited in claim 13, wherein the partial codes are checked using various code checkers.

17. The method as recited in claim 12, wherein:
at least one of the at least one code reducers includes multiple full adders, in a first code reducer, n/2 full adders are used,
a summation bit of one full adder is led in each case to a transfer input of the next full adder and the n/2 transfer bits of the n/2 full adders are output,
the transfer input of the first full adder is connected to an output of a first counter bit and this signal forms a first signal pair with a summation output of the last full adder.

18. The method as recited in claim 17, wherein:
a second code reducer includes n/4 full adders,
n/2 output bits of a first step are connected to operand inputs of the full adders of the second code reducer,
summation bits of the full adders are each switched to a transfer input of the next full adder and n/4 transfer bits of the n/4 full adders are output,
a second counter bit is switched to a transfer input of the first full adder of a second step and this second counter bit, together with an output summation bit of the last full adder of the second step, form a second signal pair.

19. The method as recited in claim 17, wherein one signal is inverted for each of the signal pairs and thus modified signal pairs are formed.

20. A circuit system for checking an m out of n code, comprising:
a code checker, to which at least one code reducer is assigned, at least one of the at least one code reducers including multiple full adders, wherein:
the first code reducer uses n/2 full adders,
a summation bit of one full adder is led in each case to a transfer input of the next full adder,
n/2 transfer bits of the n/2 full adders are output,
a transfer input of a first full adder is connected to an output of a first counter bit and this signal, with a summation output of the last full adder, form a first signal pair.
